(19) United States
(12) Patent Application Publication
(10) Pub. No.: US 2003/0014325 A1
(43) Pub. Date: Jan. 16, 2003

(54) Automatic pricing and negotiation system

(76) Inventors: Peter Biffar, Palo Alto, CA (US); Rodger Davis Keesee, San Francisco, CA (US)

Correspondence Address: GLENN PATENT GROUP, 3475 EDISON WAY, SUITE L, MENLO PARK, CA, 94025, US

(21) Appl. No.: 10/102,945

(22) Filed: Mar. 20, 2002

Related U.S. Application Data
(60) Provisional application No. 60/301,551, filed on Jun. 27, 2001.

(51) Int. Cl. G06F 17/60

(52) U.S. Cl. 705/26

(57) ABSTRACT

A method and apparatus is disclosed which generates the price for an item dynamically and allows the user to participate in the finding of the final price via negotiation. The price generated is based on the user's profile as rated along a number of dimensions, which describes the likelihood that the user finds the pricing attractive and make a purchase directly or enter into a negotiation process. At the same time, the price offered also satisfies a number of criteria set by the seller.

### CROSS-REFERENCE TO RELATED APPLICATIONS

This application claims priority to U.S. Provisional Patent Application No. 60/301,551 filed Jun. 27, 2001.

### BACKGROUND OF THE INVENTION

1. Technical Field

The invention relates to negotiation systems. More particularly, the invention relates to an apparatus and to a family of methods that automatically and dynamically negotiate prices with a consumer.

2. Description of the Prior Art

The pricing of goods and services, for example in the air cargo service, is typically a function of the amount of volume purchased. With regard to the air cargo service for purposes of example, the more space a shipper purchases, the lower the price per volume a carrier charges. Prices are set ahead of time as the customer negotiates a contract with the carrier. A carrier charges a price, while the shipper commits himself to a shipment. A shipper who is a regular customer, having periodic shipping needs, can also get a lower price per volume. The problem with such a system is that a shipper needs are not always predictable. What is needed is an automatic system for negotiating a shipping price.

Shippers must often rely on price lists. Carriers, used by freight forwarders, publish price lists. For air transport, a price list contains a schedule of flights and a price breakdown for the amount of volume purchased. The problem with price lists are that they are updated every couple of months. Such price lists do reflect changes or special rates that may be offered. What is needed is a system where price fluctuations can be posted in real-time. Furthermore, in the business-to-business (B2B) environment, most Websites do not differentiate their pricing schemes according to the buying power of the shipper, for a given location. For example, Forwarder A purchases $1 million of cargo space a year, 90% of the space is for flights to Asia, the remaining to Europe. Forwarder B, also purchases $1 million annually, but 90% are to Europe, and 10% to Asia. Today, both forwarders receive the same price list based upon $1 million of buying power. However, a more appropriate price list would give Forwarder A, who has more buying power in Asia, prices which are cheaper to Asia than Forwarder B. Likewise, Forwarder B should receive lower prices for Europe than Forwarder A. What is needed is an automatic negotiation system that recognizes the regional buying power of a forwarder.

Presently, some online sites do give the ability to vary a price. However, such price variances are limited to the online auction setting where a bidder can bid against other bidders to purchase an item. Reverse auctions also exist where the bidder states a price, and it is up to a seller to agree or say no to the price. However, an auction system lacks the ability to account for individual negotiation styles or payment histories, and thus is ill-suited for the cargo transportation world. What is needed is an automated negotiation system that can take into account each individual bidder.

In the retail world, if an item is out of stock, a customer is offered a similar item so that the customer can weigh whether they will purchase the item. Currently however, in the transportation business, the main variable is price. What is needed is system which can offer substitute services or products and which can vary such things as level of service and times available.

### SUMMARY OF THE INVENTION

The method and apparatus herein discloses a system that automatically negotiates pricing, terms, and conditions in connection with the purchase of goods and services. The invention is described herein, solely for purposes of example, in connection with a cargo shipment between a shipper, and a freight forwarder and/or a reseller of freight forwarder services. A shipper first views a list of available shipping routes then selects those on which he wishes to bid. The shipper can then bid on such variables as airline, departure date, arrival date, route, service level, and origin and destination of the shipment. The system then alters the shipping variables to meet the shipper's bid closer. The amount the system is willing alter the original variables to meet the shipper's bid depends on a shipper rating system. The shipper rating is function of such factors as reliability, payment history, and negotiation strategy.

A pricing system is used which calculates a scoring discount based on forwarder attributes, and the amount the forwarder ships to a region. Forwarder attributes comprise price sensitivity, reliability, payment history, negotiation pattern, and strategy.

### BRIEF DESCRIPTION OF THE DRAWINGS

FIG. 1 is a flowchart illustrating how the final price of a shipment is derived according to the invention;

FIG. 2 is a diagram illustrating factors used to derive a scoring discount according to the invention;

FIG. 3 is a diagram illustrating price breaks according to the invention;

FIG. 4 is graphical user interface used to edit a forwarder profile according to the invention; and

FIGS. 5A, 5B and 5C are diagrams illustrating a graphical user interface used by a shippee to negotiate a price for a shipment.

### DESCRIPTION OF THE PREFERRED EMBODIMENT

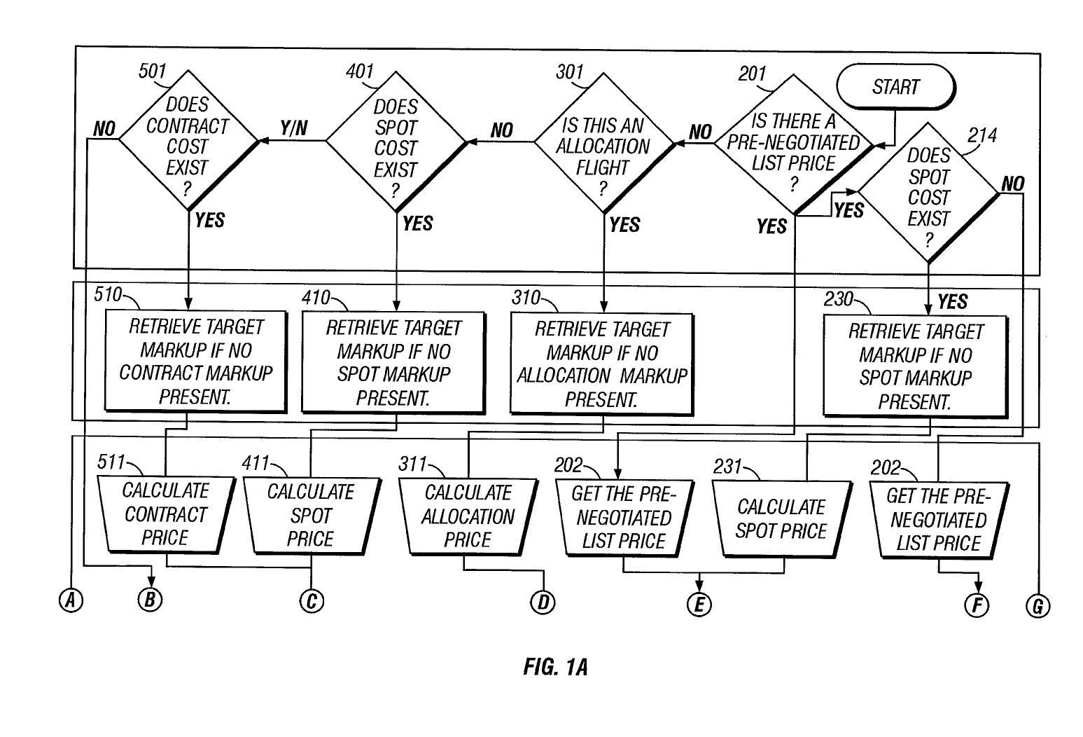

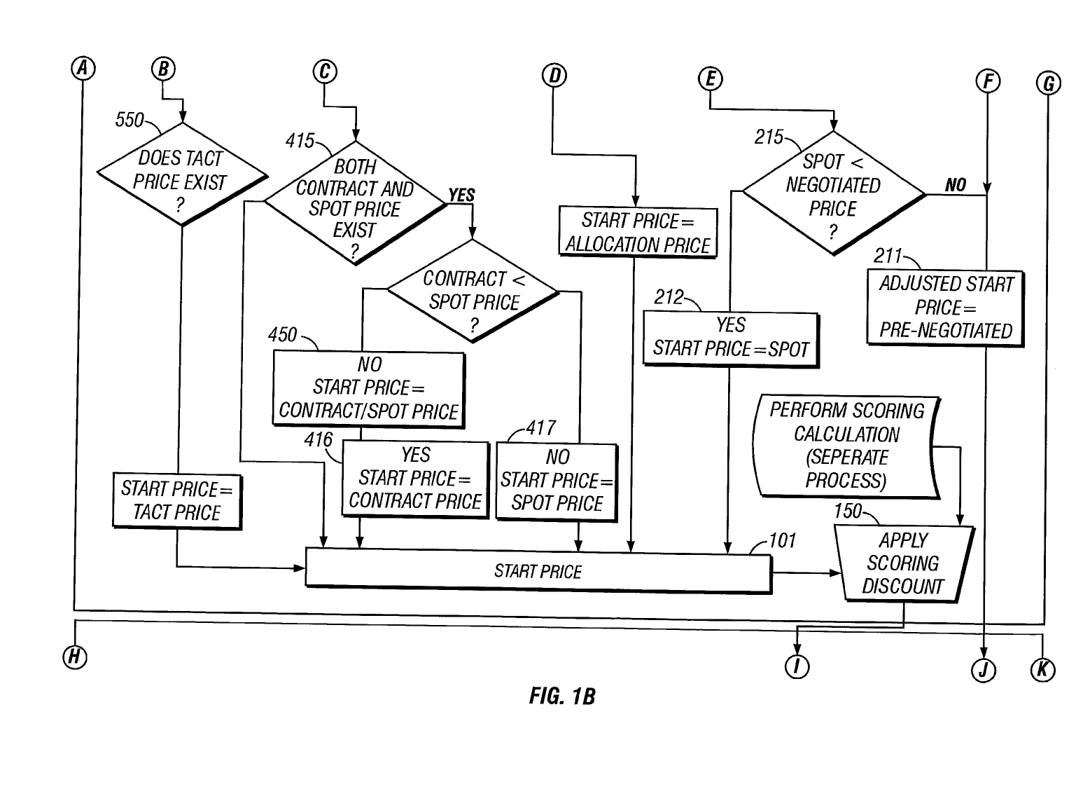

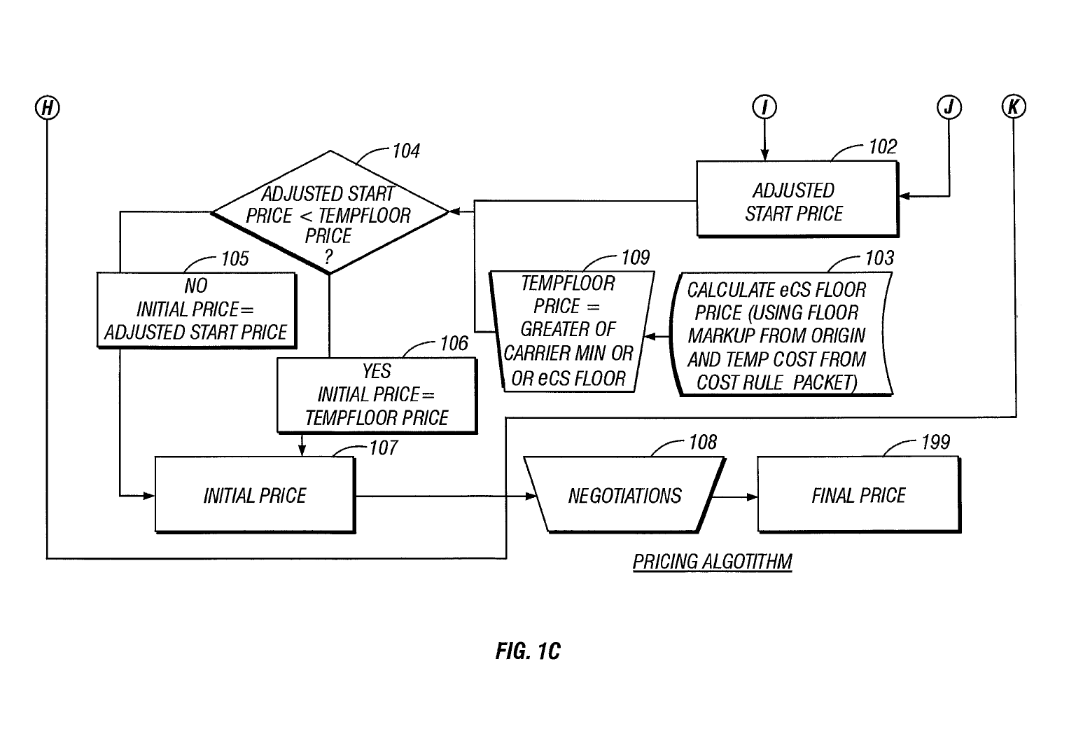

The invention is described herein, solely for purposes of example, in connection with the shipping of cargo. The system comprises multiple units that are used to calculate the price offered to a customer. In FIG. 1, multiple costs are reconciled to arrive at a start price 101. The start price 101 is used as a starting point from which a final price 199 can be determined. After a start price 101 is determined, an adjusted start price 102 is calculated as a function of start price 101 and a scoring discount 150. The adjusted start price 102 is then compared to a temporary floor price 104. The higher of the two prices becomes the initial price 107. If the adjusted start price is less than the temporary floor price, then the temporary floor price 106 is the initial price 107. The initial price 107 is then used as a starting point for negotiations 108 to arrive at a final price 199.

### Start Price

There can be any number of costs. Each cost has an associated markup. There is also a target markup, which is used in the cases where there is no valid cost specific markup. Target markup is predetermined based on the general market conditions and prevailing rates. The target markup is applied as a default markup to any and all applicable costs to arrive at a market price for the product. There are also carrier and floor markups. Carrier markups are a function of the carrier, originating airport, and service level. Floor markups are a function of the originating airport. The costs are ranked based on most valuable for the service provider, or by some other method. In the current embodiment, the costs are prioritized based on a combination of contractual requirements and market forces. The start price is either based upon a spot cost 401, contract cost 501, tact cost 550 or allocation cost 301. The start price 101 is a price from where the system can apply a scoring discount 150.

### Allocation Cost

The allocation cost is the cost of the space booked by the system provider with the carriers, that is then resold to the FORWARDERS. The allocation cost is defined for short periods of time and overrides the contract cost in effect for that time. Allocation costs can be applied to any combination of carrier, origin, destination, flight number, start date, end date, weight break and service level. Allocation costs can be independent of the actual flights taken. Service levels vary amongst different carriers, but typically include ground, standard and express. Costs of shipping vary depending on the type of service used. Weight breaks are a range of discounts that vary according to the range of weight for the cargo shipped, the greater the weight, the greater the weight break. Referring to FIG. 1, if there is no pre-negotiated price 201 then an inquiry is made whether the flight in question is an allocation flight 301. If it is an allocation flight, then the allocation cost is marked up by an allocation markup, or by a target markup if no allocation markup is present 310, 311. The allocation markup is predetermined based on business needs and general market conditions.

The calculation of the allocation price 31 1, results in the start price 101.

### Spot Cost

Spot costs are based on promotional rates offered by a carrier for a specific period of time. They are typically cheaper than a contract cost. Spot costs can be defined by any number of attributes. In the current embodiment, the Spot costs are defined by any combination of carrier, origin, destination, flight number, start date, end date, weight break and service level. Spot costs can be independent of the actual flights taken.

Referring to FIG. 1, if there is no pre-negotiated price 201, and the flight is not an allocation flight 301 then a spot cost is used if it exists 401. To calculate the spot price 411 the spot markup is used, or if there is no spot markup, then the target markup is used 410. If there is no contract price then the spot price is used 450. If there is both a contract and spot price 415, then start price is the contract price if the contract price is lower than the spot price 416. If the spot price is lower than the contract price, then the spot price is used as the start price 417.

### Contract Cost

The contract cost is a cost defined by a contract between the system provider and the carriers. The contract cost is a function of the origin to destination, service level and weight breaks. The contract cost is valid for the time specified in the contract, typically defined by a start and end date.

If there is no pre-negotiated price, or if the flight is not an allocation flight, then the systems checks whether a contract cost exists 501. If there is a contract cost, then the contract cost is marked up by a contract markup, or if none exists, by a target markup 510. The result is a contract price 511. If there is no spot price, then the start price is the contract price 450. If there is both a contract and spot price 415, then start price is the contract price if the contract price is lower than the spot price 416. If the spot price is lower than the contract price, then the spot price is used as the start price 417.

### TACT Price

If there is no contract cost, then the system checks whether there is a tact price 550, if there is, then the start price 101 is equal to the tact price.

TACT price data is an industry standard that applies to all carriers. The TACT price is a function of the origin to destination, weight break and service level. TACT price is valid for a specified period of time.

### Scoring Discount

Once the start price is determined, then it is multiplied by a scoring discount 150, which results in the adjusted start price 102. The scoring discount, in a preferred embodiment, has two main parts, a forwarder score and a regional score. The discount can be either positive or negative, thus making the adjusted start price 102 higher or lower than the start price 101.

### Forwarder Score

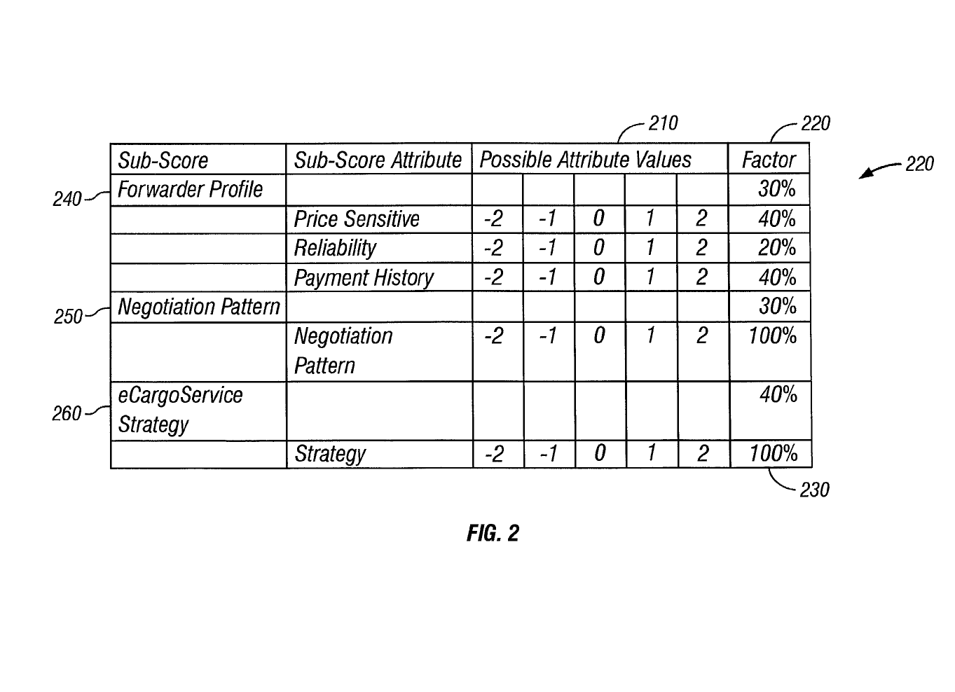

FIG. 2 is a chart illustrating a forwarder scoring system 200 used to calculate the price that is offered a forwarder. A number of sub-scores are used to calculate the forwarder score. Each sub-score has a number of attributes 210 and percentage factors 220 that determine the sub-score's contribution to the forwarder score. The total of the percentage factors is equal to 100% 230. Sub-scores may also be applied to an individual who handles the same duties as a forwarder. Each sub-score represents a trait of the forwarder. Each sub-score is easily modifiable through a graphical user interface. In the preferred embodiment, sub-scores correspond to the following attributes:

Very strong (−2)

Strong (−1)

Normal (0)

Weak (1)

Very Weak (2)

A default value of zero is used if the value for the member is not defined. Often, FORWARDERS have parent organizations. In those circumstances, the parent organization's attribute value should be used. If the parent organization does not have an attribute value, then a search up or organizational chain should be performed until an organization that does have an attribute value is found.

The sub-scores are divided into three main categories, forwarder profile 240, negotiation pattern 250, and service strategy 260.

### Forwarder Profile

In a preferred embodiment, the forwarder profile has three attributes, price sensitivity, reliability, and payment history. Price sensitivity is a measure of the client's acceptance of price fluctuations, taking into account the buying power the client has in the general market.

Reliability is a measurement of a forwarder's reliability. Factors that go into weighing a forwarder's reliability are its on-time delivery history and the number of times forwarder has cancelled a contract.

Payment history is a measure of the forwarder's accountability in making payments. Factors that are considered in this rating are, percentage of payments made on time and accounts payable vs. accounts receivable.

### Negotiation Pattern

Negotiation pattern attributes measure the typical negotiation pattern that the forwarder follows. A forwarder receives a higher score if he typically bargains unreasonably. Some examples are, the forwarder attempts to bargain when given a reasonable price and the forwarder does not offer a higher volume discount. On the other hand, a forwarder receives a lower score if he typically bargains reasonably.

### Service Strategy Measures

Service Strategy measures the importance of a specific forwarder to the long terms business goals of the system provider. The factor 220 is a percentage value that gives weight to each attribute. The higher the percentage, the greater weight the attribute is given. The factor value given each attribute may vary.

The forwarder score is calculated by taking each attribute value 210 and multiplying it times its corresponding factor 220, then adding up all the values. For example, FIG. 2 illustrates a calculated result where each attribute has the following attribute value:

| | |
|---|---|
| Price Sensitivity: | −1 |
| Reliability: | 2 |
| Payment History: | 1 |
| Negotiation Pattern: | 1 |
| Strategy: | 2 |

Each attribute value 210 is multiplied by its corresponding factor 240 and sub-score factor 241. Using the present example, the calculation is (−1*40% +2*20%+1*40%)*30%+(1*100%)*30%+(2*100%)*40%=1.22. Thus, the forwarder score is 1.22.

### Region Score

Region scores are unique scores that are assigned to a region based on the buying power of a FORWARDER in that region. Regions are typically divided by continent but could be as specific as an airport. Examples of such regions are Africa and Asia. A region score is derived by the multiplication of a region sub-score percent factor by a region sub-score. Sub-scores may be added, deleted, or modified. In a preferred embodiment, the possible region sub-scores are:

Much More than Normal (−2)

More than Normal (−1)

Normal (0)

Less than Normal (1)

Much Less Normal (2)

Each region has a weight that used to determine the relative importance of that region. The region score is multiplied by the applicable region weight to arrive at the final region score. The regions weights need not add up to %100. For example, if a FORWARDER delivers to Asia much more than normal, and Asia has a region weight of 30%, then the region score will be −2*30%=−0.6.

### Discount Table

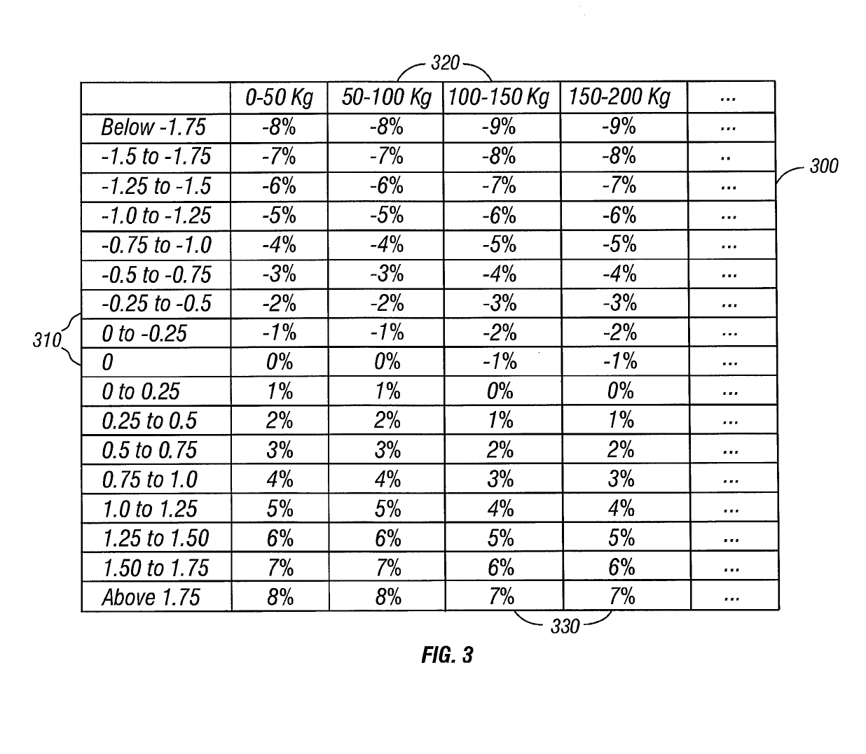

FIG. 3 is chart illustrating a preferred embodiment of a discount table. The discount table is one way to convert the user score to a discount. The discount table 300 is a mapping of scores 310 and weight breaks 320 to discount factors 330.

For example, if cargo to be shipped has a mass of 130 kg, and the forwarder has an attribute value of −1.30, then the forwarder receives a discount of −7%. Thus, 7% is deducted from the start price value.

### Client Pre-Negotiated Prices

If there is a pre-negotiated price list 201, 202, and a spot price 214, then the pre-negotiated price is compared to a spot price 215. If a spot cost exists, the spot cost is marked up by the spot mark up, or by a target markup if no spot markup exists 230, 231.

If the pre-negotiated price list is less than the spot price 21 1, then the pre-negotiated price is used as the adjusted start price 102. If the spot price is less than the negotiated price 212, then the start price is the spot price 102. If no spot cost exists the pre-negotiated price becomes the adjusted start price 102.

Pre-negotiated price lists are defined for freight forwarders (FORWARDERS) per any combination of the following; origin, destination, service level, airline, and weight break. The pre-negotiated price lists may be valid for a specified period of time, and prices may be based on weight and volume. The pre-negotiated price lists may be for a specific carrier, or for all carriers.

### Minimum and Maximum Prices

Any number of minimum or maximum prices can be used to ensure the initial price is within predetermined values ranges. One embodiment uses vendor minimum price 109 and floor price 103. Vendor minimums could be applied to a specific product. For example, a specific flight on a specific day or applied to any combination of originating airport, destination airport, flight, weight break and service level. A floor price is the applicable cost determined above with a floor markup. Floor markup is a predetermined percentage based on business needs and the general market. The temporary floor price is the greatest of all the minimum prices. The adjusted start price is compared to all minimum prices. The highest price becomes the initial price 107. The adjusted start price is then compared to all maximum prices. The lowest price becomes the initial price.

### Promotions

Promotional offers are made periodically. In a preferred embodiment, the offers have specific options such as, carrier, flight number, FORWARDER, weight and volume requirements, time, time for booking, day of departure and level of service. For example, a 10% discount is available for a flight on TWA from Dulles airport to LAX, departing on Jun. 30, 2001, must be booked by Apr. 10, 2001, the weight of the transported object must be between 300-500 kg, cannot exceed 5 cu/ft, deferred service, offered only to specific FORWARDERS.

The savings made by promotional offers are made, in a preferred embodiment, by stating, the price per kilogram, percent off the adjusted initial price, and price deduction off of the adjusted initial price.

In a preferred embodiment, both the initial price and promotional price are made available to a shipper. If the promotional price is lower than the initial price, then a shipper cannot negotiate with the promotional price. If the promotional price is higher than the initial price, then the shipper can negotiate. This situation typically arises where the shipper has a favorable customer status.

### Scalability

The system is scalable such that different factors such as options, costs types, markups, client scoring attributes, maximum and minimum prices can be added to the system. The factors are added by adding another number into the algorithm used to calculate the adjusted start price. The factors are also added as variables in the negotiation process.

### Shipper Interface

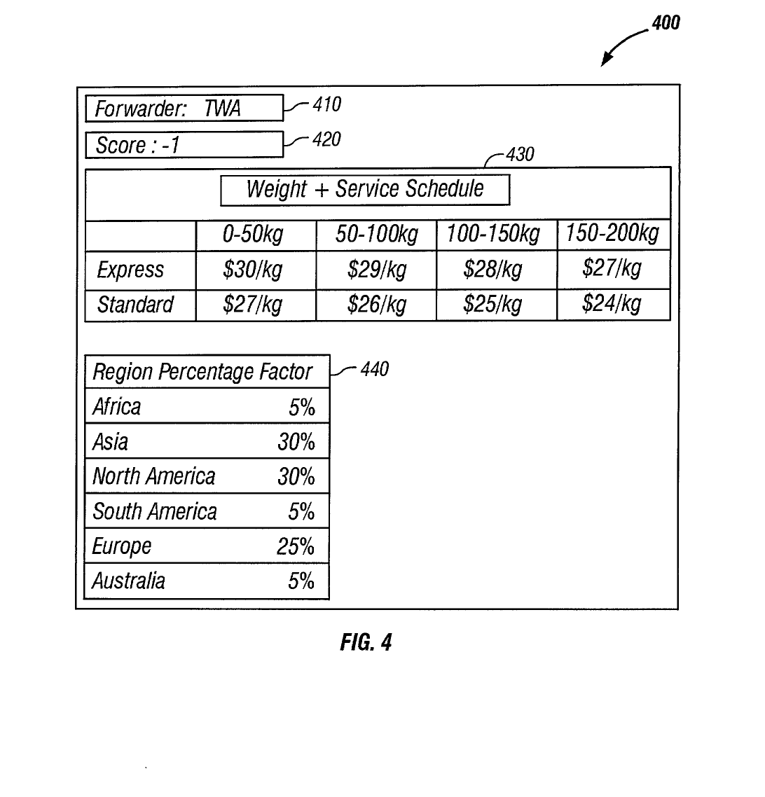

A graphical user interface (GUI) is used to add, modify and search costs and lists such as, contract costs, spot costs, TACT costs, shippee negotiated price lists, and minimum price lists. FIG. 4 illustrates a GUI 400 used to edit contract costs. The GUI contains such information as the forwarder name 410, forwarder score 420, weight and service schedule 430, and region percentage factors 440. A system moderator clicks on a box to change its value.

Similarly, the system uses GUI's to modify carrier, target, and floor markups, adjustment factors, sub-scores, sub-score percent factors, discount tables, promotions, and attribute definitions.

### Negotiations

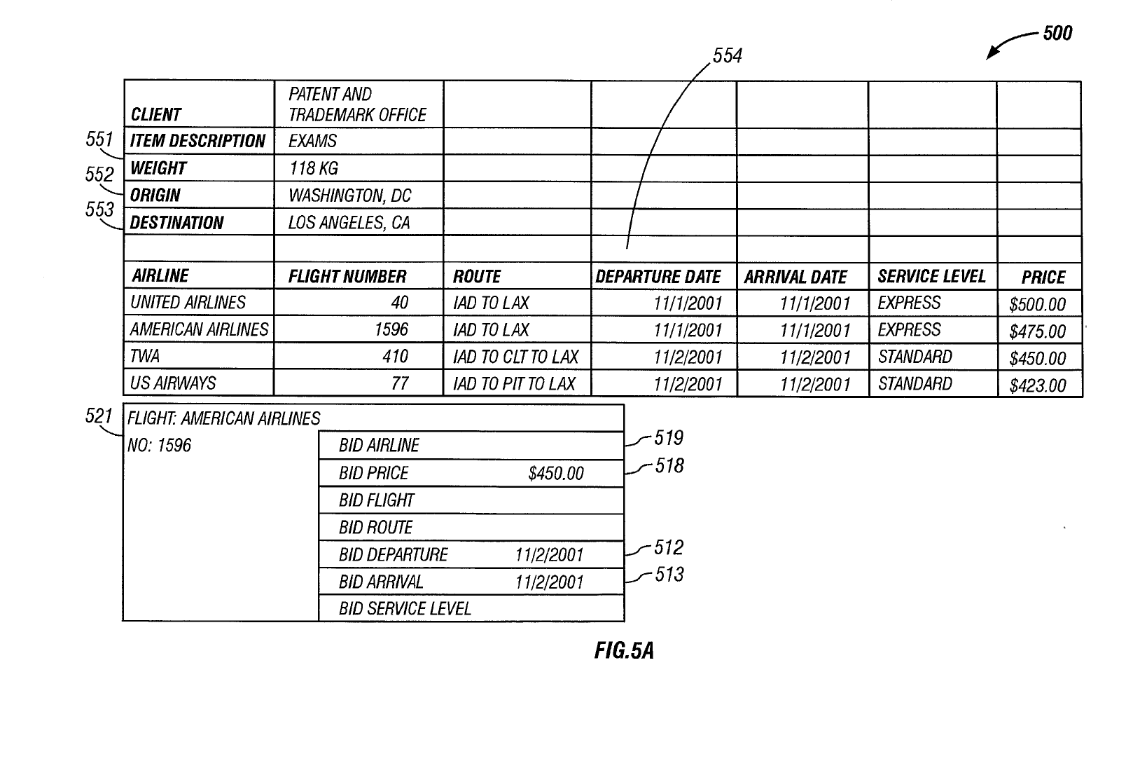

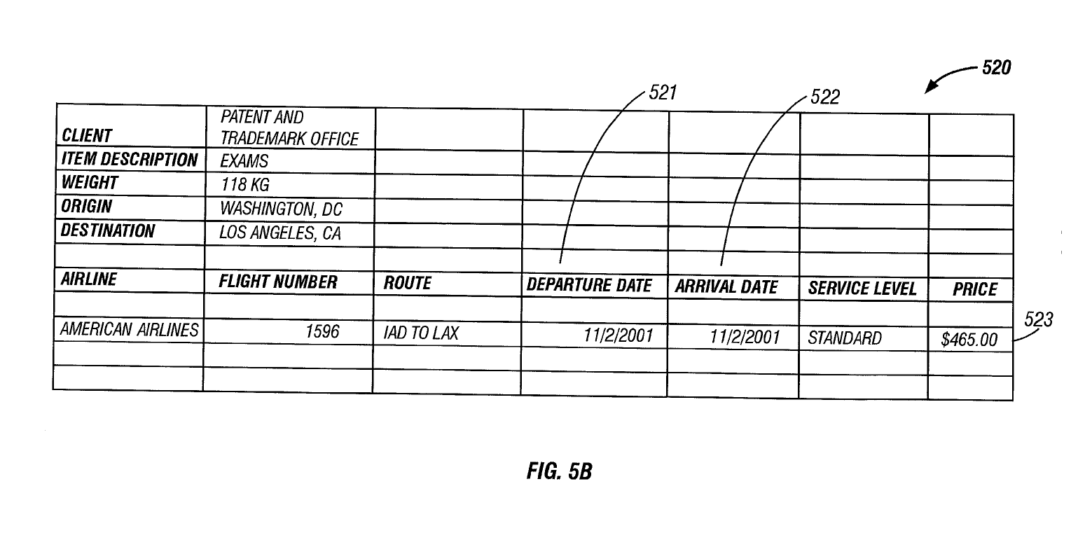

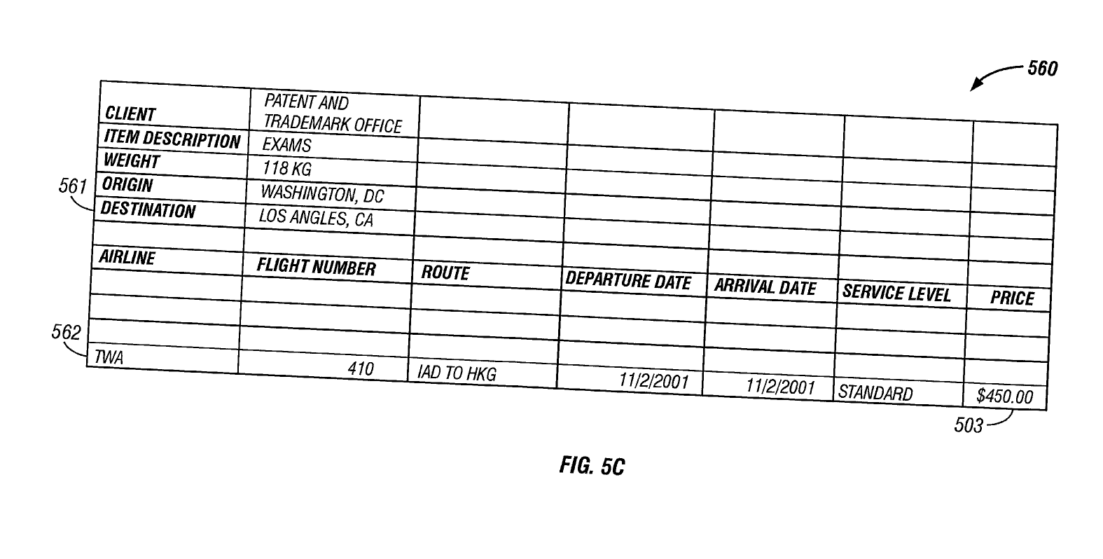

The negotiations module 108 provides an automated system for negotiating with a shipper along many variables. In a preferred embodiment, the variables include price, airline, departure date, arrival date, routing, service level, origin, and destination. The automated system repeatedly offers and counter-offers in response to a shipper's offers and counter-offers until an offer is accepted. Typically a shipper knows such variables as the weight of the cargo to be shipped, the origin, destination, and the desired time for departure and arrival. FIG. 5A illustrates a results screen, which lists flights that have met shipper inputted search variables for a 118 kg cargo 551, shipped from Dulles airport in Washington D.C. (IAD) 552 to Los Angeles International Airport (LAX) 553, to depart on Nov. 01, 2001 554. The list of flights has a range of prices, listed by price in descending order. It is contemplated that a shipper can manually enter a specific flight. A shipper selects a flight in which he is interested, and bids on certain aspects of the flight in the bid section of the screen. In FIG. 5A, the shipper has chosen to negotiate with American Airlines flight No. 1596 521. The bid section 519 allows a shipper to negotiate chosen criteria. The shipper has chosen to negotiate the price 518, departure date 512 and arrival date 513. The price is $450 instead of $475, and the departure and arrival date is Nov. 12, 2001, instead of Nov. 11, 2001.

FIG. 5B illustrates a counter-counter offer in response to the counter-offer made by the bidder shipper. The results 520 are representative of the criteria the shipper has chosen, and on what the automated system is programmed to negotiate. The departure 521 and arrival dates 522 are the same as the shipper has bid, Nov. 02, 2001 and Nov. 02, 2001, respectively. The price 523 is $465.

In a preferred embodiment, the system is designed to negotiate prices based on the profile of the shipper, maximizing the profit, and substituting products. Intelligence rules well known in the art track shipper preferences, for using certain carriers and negotiation patterns. In the above example, the system determined that price, and departure and arrival time, were important to the shipper, so the system adjusted the offer by changing the departure and arrival time, and by lowering the price.

Alternatively, FIG. 5C illustrates an offer 560 made in response to a shipper bid, where no flight was available on the bid departure and arrival time, and where an alternate carrier can offer a lower price than the bid carrier. Also, in this example, the destination is Hong Kong (HKG) 561 instead of LAX. In this example, the system weighs the price as being more important than the departure and arrival time, because the shipper's original search requested a different departure and arrival. Also, because no flight was available on the carrier requested, an alternate carrier 562 was offered. The alternate carrier is chosen based on a hierarchy of past shipper preferences for carriers.

In this example the system can meet the price 563 bid by the shipper because TWA has a better regional score than American Airlines, i.e. TWA ships more to Asia than American Airlines, so the price bid by the shipper can be met. In the previous example, $465 for American Airline was the price offered in response to the shipper counter offer. In this example, the shipping strength of TWA to Asia results in a lower price counter-offer of $450 to the shippee.

It is also contemplated that discount vouchers on future shipments can be offered, especially where it is not possible to lower the price on a bid.

Accordingly, although the invention has been described in detail with reference to particular preferred embodiment. Persons possessing ordinary skill in the art to which this invention pertains will appreciate that various modifications and enhancements may be made without departing from the spirit and scope of the claims that follow.

1. A method for negotiating a contract, between a purchaser and a seller, on a reseller computer system, comprising the steps of:
offering by a reseller an initial contract based on purchaser chosen variables;
counter-offering by said purchaser, said counter-offer differing from said initial contract on more than one variable; and
counter-counter offering said counter-offer with counter-counter offer, said counter-counter offer differing from said initial offer by more than one variable.

2. The method of claim 1, further comprising the step of:
entering a search query of contract variables by said purchaser.

3. The method of claim 1, wherein said contract is for the shipment of cargo.

4. The method of claim 3, wherein said contract variables comprises any of:
price of shipment, airline, departure date, arrival date, route, service level, and origin and destination of shipment.

5. The method of claim 4, wherein said price of said shipment is determined by applying a scoring discount to a freight forwarder.

6. The method of claim 5, wherein said scoring discount comprises any of:
a forwarder score and a regional score.

7. The method of claim 6, wherein said forwarder score is based on factors comprising any of:
price sensitivity, reliability, payment history, negotiation pattern, and strategy.

8. The method of claim 6, wherein said regional score is a function of the amount of cargo said forwarder ships to regions.

9. The method of claim 8, wherein said regions are divided by geographic areas.

10. The method of claim 1, wherein a price of said contract is a function of shipper attributes.

11. The method of claim 10, wherein said shipper attributes comprises any of:
preferences for a certain carrier, negotiation pattern, payment history, and reliability.

12. The method of claim 1, further comprising the step of:
updating in real-time a schedule of prices for said contract.

13. An apparatus for negotiating a contract, between a purchaser and a seller, on a reseller computer system, comprising:
an initial contract based on purchaser chosen variables offered by a reseller;
a counter-offer by said purchaser, said counter-offer differing from said initial contract on more than one variable; and
a counter-counter offer, said counter-counter offer differing from said initial offer by more than one variable.

14. The apparatus of claim 13, further comprising:
a search query of contract variables by said purchaser.

15. The apparatus of claim 13, wherein said contract is for the shipment of cargo.

16. The apparatus of claim 15, wherein said contract variables comprises any of:
price of shipment, airline, departure date, arrival date, route, service level, and origin and destination of shipment.

17. The apparatus of claim 16, wherein said price of said shipment is determined by applying a scoring discount to a freight forwarder.

18. The apparatus of claim 17, wherein said scoring discount comprises any of:
a forwarder score and a regional score.

19. The apparatus of claim 18, wherein said forwarder score is based on factors comprising any of:
price sensitivity, reliability, payment history, negotiation pattern, and strategy.

20. The apparatus of claim 18, wherein said regional score is a function of the amount of cargo said forwarder ships to regions.

21. The apparatus of claim 20, wherein said regions are divided by geographic area.

22. The apparatus of claim 13, wherein a price of said contract is a function of shipper attributes.

23. The apparatus of claim 22, wherein said shipper attributes comprises any of:
preferences for a certain carrier, negotiation pattern, payment history, and reliability.

24. The apparatus of claim 13, further comprising:
real-time updates of prices for said contract.
